(19) United States
(12) Patent Application Publication
(10) Pub. No.: US 2014/0229146 A1
(43) Pub. Date: Aug. 14, 2014

(54) IN-SITU OPTIMIZATION OF CHILLED WATER PLANTS

(71) Applicants: Igor F. Gonzalez, Doral, FL (US); Hari Kishore Adluru, Miami, FL (US); Aparna Aravelli, Lauderdale by the Sea, FL (US)

(72) Inventors: Igor F. Gonzalez, Doral, FL (US); Hari Kishore Adluru, Miami, FL (US); Aparna Aravelli, Lauderdale by the Sea, FL (US)

(73) Assignee: ENTIC, LLC, Pembroke Pines, FL (US)

(21) Appl. No.: 13/763,597

(22) Filed: Feb. 8, 2013

(51) Int. Cl. G06F 17/50

(52) U.S. Cl. CPC G06F 17/5009
USPC 703/2

(57) ABSTRACT

A model based optimization method for determining optimized operating conditions to minimize overall power consumption of a chiller plant includes identifying each of the plurality of chiller plant subsystems in the chiller plant, generating a chiller performance model and a chiller stalling model, generating a cooling tower performance model, generating a chilled water pump performance model, generating a condenser water pump model, formulating a chiller plant optimization model, receiving chiller plant input data from the chiller plant, solving the chiller plant optimization model using the chiller plant input data, generating optimized chiller plant subsystems outputs, comparing the optimized chiller plant subsystems outputs to current operating chiller plant subsystems, generating projected energy savings of the optimized chiller plant subsystems, comparing the projected energy savings to an energy saving threshold value, when the projected energy savings exceeds the energy saving threshold value, sending the optimized chiller plant subsystems output to a building control system.

### BACKGROUND OF THE INVENTION

1. Field of the Invention

The present invention relates to heating, ventilation and air-conditioning (chilled water) plants and more particularly to the optimization of chilled water plants.

2. Description of the Related Art

A chilled water plant provides the necessary cooling to a building through chilled water. The main components of a chiller plant are chillers, cooling towers, and pumps. These are often grouped together to form the “condenser loop” and the “chilled water loop”. The condenser loop consists of chiller condensers, pumps, cooling towers and fans whereas the major components of the chilled water loop are the chiller evaporators and chilled water pumps.

Building load is handled by the chillers and the heat produced by the chillers is carried over to the cooling towers which reject the heat to the ambient atmosphere. The cooling towers have large fans at the top of the tower to draw air counter flowing to the water. Water in the chillers and cooling towers is circulated using pumps (mostly centrifugal pumps). It is common in the chilled water plants to arrange multiple chillers and cooling towers in parallel. The performance of a chiller plant is indicated as the ratio of electric power consumed to the demanded building load and is commonly given in kilowatt per ton (kW/ton).

The most common arrangement for chilled water systems is to set the chilled water supply temperature (CWST) to a specific value. The fan speeds in the cooling towers are adjusted to deliver set CWST temperature, e.g., 80° F. In order to meet building load requirement, the chillers are adjusted at partial load conditions, based on the number of chillers being operating at that particular instant. Typically, an extra centrifugal chiller is powered on when the other operating chiller(s) reaches a preset percent operating load (e.g., 95%). Similarly, if the chillers are running at low percent load (e.g., 50%), one of the chillers is powered off.

### BRIEF SUMMARY OF THE INVENTION

Embodiments of the present invention address deficiencies of the art in respect to chilled water plant and provide a novel and non-obvious method, system and computer program product for optimizing the energy use of a chilled water plant. In an embodiment of the invention, a model based optimization method for determining optimized operating conditions to minimize overall power consumption of a chiller plant includes identifying each of the plurality of chiller plant subsystems in the chiller plant, generating a chiller performance model and a chiller stalling model, generating a cooling tower performance model, generating a chilled water pump performance model, generating a condenser water pump model, formulating a chiller plant optimization model, receiving chiller plant input data from the chiller plant, solving the chiller plant optimization model using the chiller plant input data, generating optimized chiller plant subsystems outputs, comparing the optimized chiller plant subsystems outputs to current operating chiller plant subsystems, generating projected energy savings of the optimized chiller plant subsystems, comparing the projected energy savings to an energy saving threshold value, when the projected energy savings exceeds the energy saving threshold value, sending the optimized chiller plant subsystems output to a building control system.

In an aspect of one embodiment, the chiller plant input data includes building load, ambient air conditions and number of currently operating chillers.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a chiller plant;

FIG. 2 illustrates characteristic curves of a typical chiller in a chiller plant;

FIG. 3 illustrates a system performance surface of a chiller developed from regression analysis;

FIG. 4 illustrates a characteristic curve of a typical cooling tower;

FIG. 5 is a flow chart illustrating a process for determining optimized operating conditions to minimize overall power consumption of a chiller plant ; and,

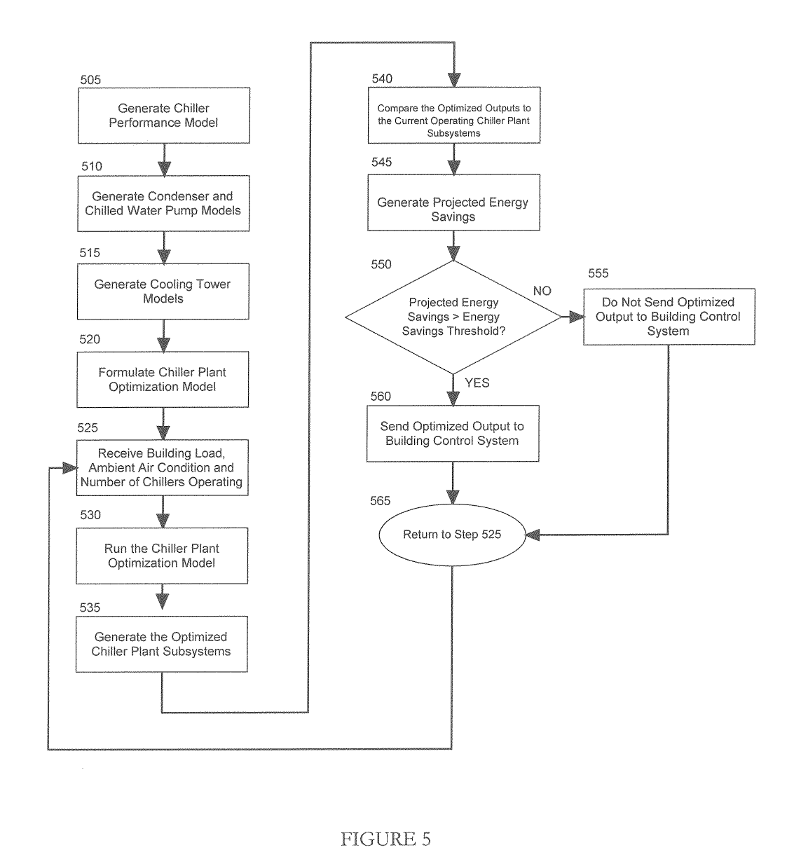

FIG. 6 is a schematic illustration of a model based optimization system with a sense and response data analyzer which interfaces with a building management system that controls a chiller plant.

### DETAILED DESCRIPTION OF THE INVENTION

Embodiments of the invention provide for determining optimized operating conditions to minimize overall power consumption of a chiller plant having a plurality of chillers of equal capacity and from the same manufacturer, a plurality of cooling towers, a plurality of chilled water pumps and a plurality of condenser water pumps arranged in parallel and coupled to a common header on a chilled water side and a common header on a condenser water side.

Most chiller plants are operated without a dynamic optimization mode. The plant controls are statically predetermined and operated using a control sequence through the Building Management System (BMS). The present invention develops a procedure and thereby creates a complete package for the in-situ or real-time/dynamic optimization of chilled water plants. This dynamic optimization leads to higher energy savings in the form of overall electrical power consumption by the plant (lower kW/ton). This procedure saves energy by finding an optimal mix of equipment and their operating levels at each instant of time for a given building load and ambient air temperature. An optimization software package is developed based on systems optimization theory which uses hybrid optimization algorithms. This optimization software could be directly integrated with the building management system with an interface.

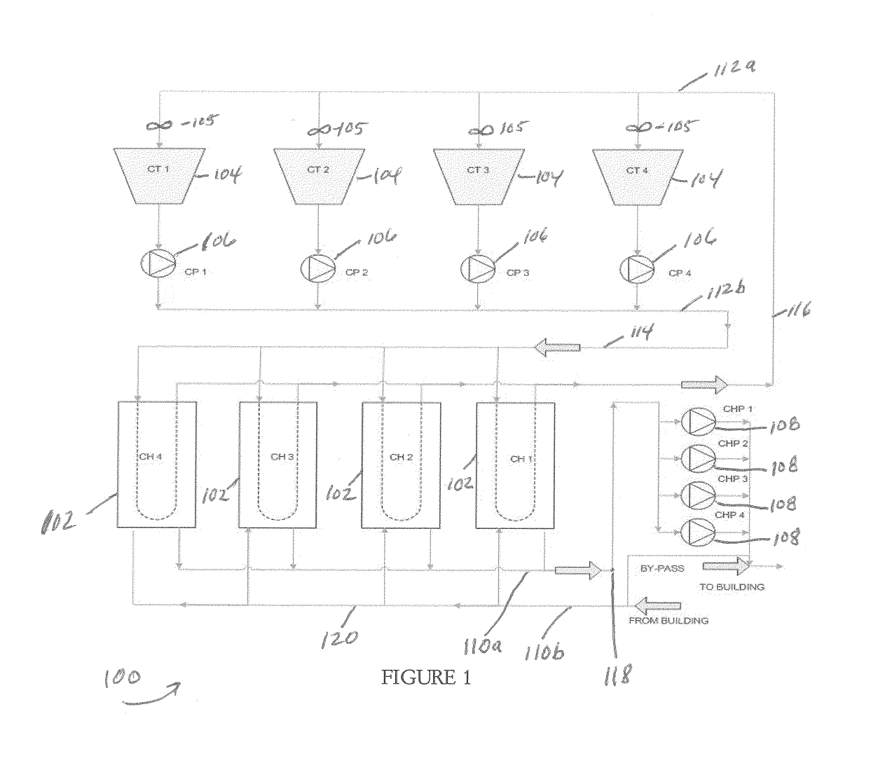

FIG. 1 is a schematic illustration of a chiller plant. The typical chiller plant can be a water cooled system 100 that includes four centrifugal chillers 102 with Variable Flow Devices (VFD) and four cooling towers 104 with variable speed fans 105. The system 100 includes four condenser water pumps 106 and four chilled water pumps 108. The chillers 102, cooling towers 104, four condenser water pumps 106 and chilled water pumps 108 are arranged in parallel and coupled to a common header 110a, 110b on a chilled water side and a common header 112a, 112b on a condenser water side. The heat from the chillers 102 is transferred to condenser water return 112a and then rejected to outside air through the cooling towers 104. The temperature of water through the system at various points is denoted as Condenser Water Supply Temperature (CWST) 114, Condenser Water Return Temperature (CWRT) 116, Evaporator Water Supply Temperature (EWST) 118 and Chilled Water Return Temperature (EWRT) 120 from the building. The amount of heat rejected to the exterior depends on the cooling tower fan speed, the flow rate of water in the cooling towers, outside ambient conditions and building cooling load. An appropriate control scheme is developed to control the system for smooth operation at all times. This control method is commonly predetermined by the Building Management System (BMS).

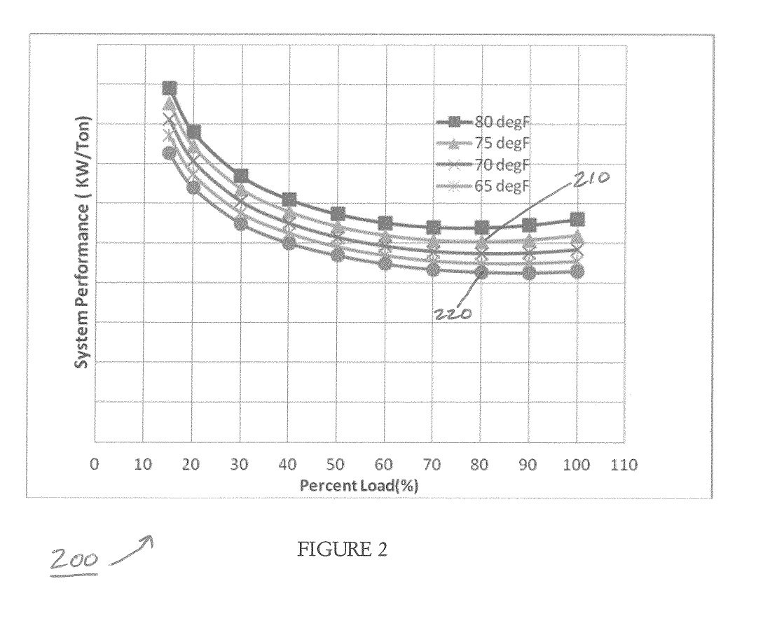

FIG. 2 illustrates characteristic curves of a typical chiller in a chiller plant. These curves are provided by the manufacturers which are 2 dimensional. Points on the curve represent system performance (KW/Ton) consumed by chiller at certain percent load and certain condenser water supply temperature (CWST). For example, Point 210 means the chiller is at 80 percent of Full Load with CWST 75° F. with system performance 5 units. Similarly, Point 220 means the chiller is at 80 percent of Full Load with CWST 60° F. with system performance 4.2 units which is 16 percent lower than previous value.

A first step in providing a procedure for the optimization of chilled water plants includes generating a chiller performance model based on non-linear regression analysis. A regression analysis model is predicted for the system performance of the chillers from the data provided by the chiller manufacturer or by actual historic performance data from the building analytical software. Initially a non-linear regression model based on all the variables including condenser water supply temperature (CWST), condenser water return temperature (CWRT), chilled water supply temperature (CHWS) and chilled water return temperature (CHWR) is considered. Furthermore, a reduced regression model using forward method is developed which eliminates the insignificant parameters depending on the chiller characteristics.

A regression model for the system performance (SP) is developed based on the percentage load (PL) and the condenser water supply temperature (CWST) and is given by:

SP=f(PL, CWST); Equation (1).

An actual regression model considered in a typical case is given by:

SP=C₁+C₂*PL+C₃*PL²+C₄*CWST+C₅*CWST²+C₆*PL*CWST Equation (2).

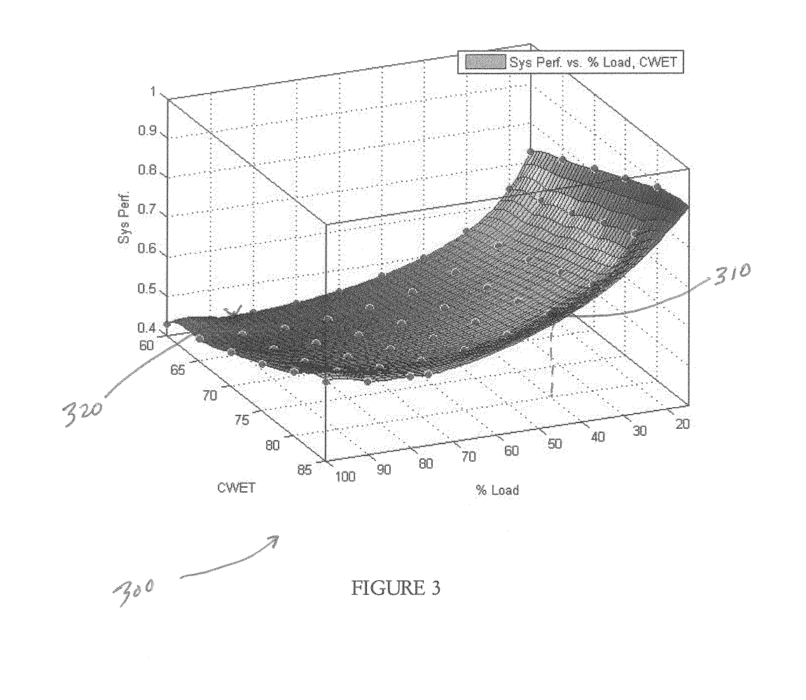

The values of the constants (C₁, C₂ . . . C₆) are determined using least squares regression analysis. The regression model curve obtained for a typical chiller is illustrated in FIG. 3. The 2-dimensional performance curves shown in FIG. 2 are thus converted to a 3-dimensional surface, which represents different system performances for different percent load of chiller and for different condenser water supply temperature. For example, Point 310 represents system performance of 0.65 at 30 percent of Full Load and CWST of 75° F. and Point 320 represent system performance of 0.45 at 55 percent of Full Load and CWST of 72° F. This 3-dimensional surface provides a clear picture of how system performance varies depending on percent load of the chiller and CSWT. It should be noted that the chiller curves differ from chiller to chiller depending on size, type, manufacture and the like.

A second step in providing a procedure for the optimization of chilled water plants includes generating a chiller stalling model based on logistic regression analysis. A logistic regression model is developed for the chiller to determine the stall/surge region. The logistic regression model developed as below:

q=Logit(Pi)=C₁+C₂*PL+C₃*CWST Equation. (3)

Therefore Pi=e^{q/}(1+e^{q}). A certain cutoff value (x₁) for Pi is considered, i.e.,

$$\begin{matrix}Probability = 1 for Pi >= {x}_{1} \\ = 0 for Pi < {x}_{1}\end{matrix}$$

The value of x₁ is chosen in such a way that both sensitivity and specificity of the Logistic regression model are higher (e.g., above 95%). C1, C2 and C3 are constants determined using logistic regression analysis. Pi is a representation of probability which is further needed to determine Staging ON and Staging OFF the chiller.

Based on the chiller performance model, the chiller operating conditions are determined and based on the chiller stalling model, the chiller is checked for its stall/surge region. For example, the plant is currently running with two chillers each at 90% of full load. Based on the input conditions like the building load and external weather conditions, the chiller performance model suggests running 3 chillers (instead of 2) at say 60% of full load with CWST of 65° F. The chiller stalling model is runs Logistic Regression analysis and calculates the Pi value which is either 0 or 1. Based on the Pi value the final numbers of optimized chillers are decided (as 2 or 3). In another example, the plant is currently running with three chillers at 90% of full load. From the building load and external weather conditions, the optimization model suggests running four chillers at approximately 67% of full load with CWST of 70° F. The optimization method further runs Logistic regression model which determines the Pi value as 0, if so then only 2 chillers are used instead of 3.

A third step in providing a procedure for the optimization of chilled water plants includes generating a regression model for cooling tower and condenser water pump. Similar procedures are incorporated to develop mathematical models for other equipment like the cooling tower fans and condenser water pumps. Considering the cooling tower, the following model is used:

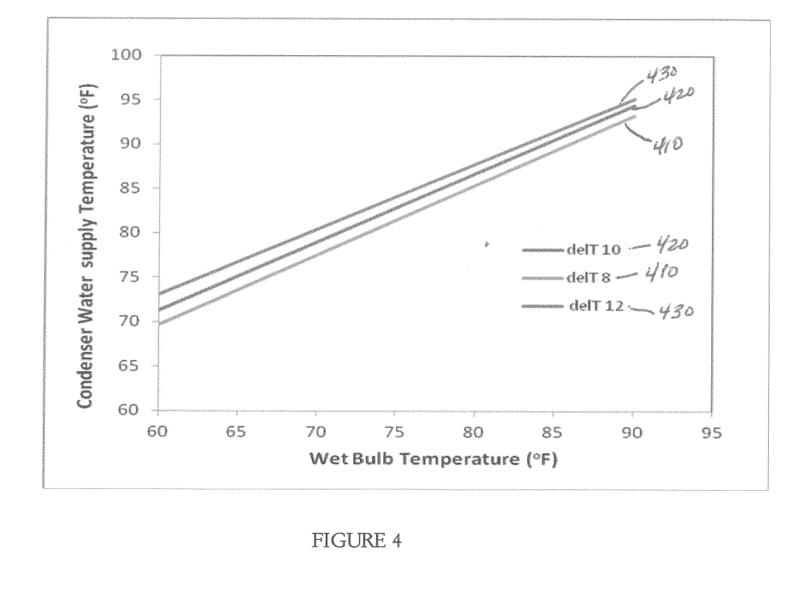

CWST=f(WBT, deltaT_{condenser},GPMₚᵤₘₚ,FanSpeed) Equation (4)

Where WBT is Wet Bulb Temperature, deltaT_{condenser} is change in temperature between Condenser Water Supply 114 and Condenser water Return 116, GPMₚᵤₘₚ is pump flow rate in gallons per minute and Fan Speed is in Hertz. The characteristic curve for a typical cooling tower is as shown in FIG. 4. If available, fan models can also be developed from information provided by the manufacturer or using general fan laws. The pump power is modeled as:

Pₚ=P_{pbhp}/η Equation (5)

where P_{pbhp}=G_{w}*H/k_{c}, H is assumed to be a function of the flow rate G_{w}, and k_{c} is treated as a constant. Hence, P_{pbhp} becomes a function of flow rate G_{w} only. Based on regression analysis of the data, the model for a typical pump can be taken as

Pₚ=C+d₁*G_{w}+d₂*(G_{w})²+d₃*(G_{w})³ Equation (6)

P_{pbhp} is Pump Brake Horse Power, G_{w} is pump flow rate in gallons per minute, H is Pump Head and d₁, d₂ and d₃ are constants determined based on the given pump characteristics.

The mathematical formulations from the regression models are integrated together based on the working cycle of a chiller plant. These integrated formulations are used in the formulation of optimization model as described below.

A general optimization model includes optimizing (minimizing or maximizing) a given aim/objective based on a set of constraints to be satisfied. The parameters in the model formulation are called the design variables.

In the present invention, the objective in the optimization model is minimization of the total electrical power consumed by all the equipment which includes the chillers, condenser water pumps, the chilled water pumps and the cooling tower fans. Hence, the objective function can be written as

f(\vec{X})=P_{ch}(\vec{X})+Pₚ(\vec{X})+P_{ctf}(\vec{X}) Equation (7)

Where P_{ch} is the power consumed by the operating chillers, Pₚ is the power consumed by the condenser and the chilled water pumps and P_{ctf} is the power consumed by the cooling tower fans. These factors depend on the set of design variables given by \vec{X} which include the number of chillers to be operated, the speed at which cooling tower fans are operated, the supply temperature of the condenser water. Also, the design variables have to be limited to certain bounds of operation based on the overall chiller plant and the equipment specifications indicated by the manufacturer.

Once the optimization model is established, it is to be solved for the optimum conditions. The mathematical model is solved using the systems optimization theory. The theory is based on robust and proven Sequential Quadratic Programming (SQP) in conjunction with the Branch and Bound (B&B) method of integer programming. A hybrid optimization algorithm is developed using SQP and B&B. Once the chiller plant optimization model is solved using the hybrid optimization algorithm, the outputs (number of chillers, fan speed) are compared with the existing plant conditions (current number of chillers running, current fan speed) and then the amount of savings (in terms of power consumed) are calculated and a decision (e.g., to stage on/off a chiller, to change the fan speed, etc.) is made if the energy savings meet a certain energy savings threshold value. If the projected energy savings exceeds the energy savings threshold, the optimization outputs are sent to the building management system for execution.

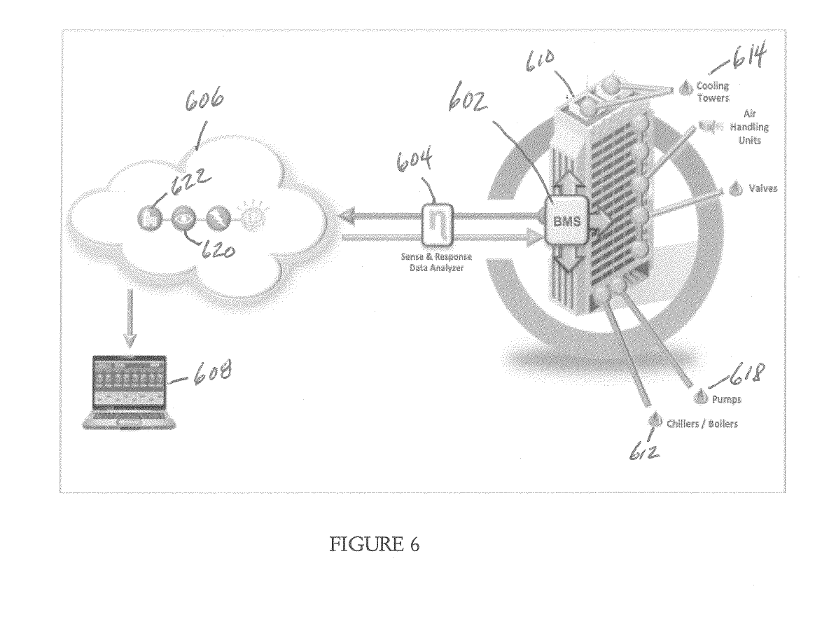

FIG. 6 is a flow chart illustrating a process for determining optimized operating conditions to minimize overall power consumption of a chiller plant. Beginning in block 505, a chiller performance model and a chiller stalling model can be generated. In block 510, a condenser water pump model and a chilled water pump model can generated. In block 515, a cooling tower model can be generated. In block 520, a chiller planet optimization model can be formulated using the generated chiller performance model, generated chiller stalling model, generated condenser water pump model and a chilled water pump model, and generated cooling tower model. In block 525, building data can be received. The building data can include building load and ambient air conditions (such as Dry Bulb Temperature and Relative Humidity as well as the number of chillers currently running) In block 530, the chiller plant optimization model can be run or solved to calculate the total power consumed by the chillers, cooling tower fans, condenser water pumps and chilled water pumps to match the building load by varying parameters such as the number of chillers, CWST and cooling tower fan speeds. In block 535, the optimized chiller plant subsystems (e.g., number of chillers, cooling towers with fan speeds, number of chilled and condenser water pumps) can be generated. In block 540, the optimized outputs of model can be compared to the current operating chiller plant subsystems. In block 545, the projected energy savings can be generated and in decision block 550, the projected energy savings can be compared to an energy savings threshold value. For example, the energy savings threshold value may be set to at least 2%, which would mean that the if the projected energy savings was less than 10%, then in block 555, the optimized output would not be sent to the building control system (BCS). On the other hand, if the projected energy savings was equal to or greater than 2%, then in block 560, the optimized output would be sent to the building control system (BCS). In block 565, the progress can return to block 525.

In yet further illustration, FIG. 6 schematically shows a model based optimization system with a sense and response data analyzer that interfaces with a building management system that controls a chiller plant. The model based optimization system can include an optimization engine that executes the model based optimization logic 620. Model based optimization logic 620 contains program code, which when executed by the optimization engine causes the polling of a translator device 604 on a regular interval to collect data for use in the model based optimization method. The translator device 604 collects chiller plant data, such as temperatures and energy usage data for the internal machinery of the chiller plant. The polled data is then transmitted to a cloud based data store 622. The optimization engine polls the data store 622 for variables for use in the model based optimization method. The optimization engine processes data, executes algorithms and then outputs results to a local data store 622. The optimization engine then polls the output data store 622 and transmits results back to the translator device 604. Translator device 604 sends the commands to the machinery, e.g., cooling towers 614, pumps 618 and chillers 612, of the building via a building management system (BMS) 602.

The cloud 606 can include one or more host computers, each with at least one processor and memory. The host computers cooperatively can be managed by a cloud computing environment upon which multiple different virtual machines can execute in a cluster. The virtual machines, in turn, can manage the operation of computer program logic deployed into the cluster of virtual machines. The cloud computing environment also can include one or more servers. Although the model based optimization system is illustrated as a cloud-based system, the model based optimization system can also be deployed on premises with the building management system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A model based optimization method for determining optimized operating conditions to minimize overall power consumption of a chiller plant having a plurality of chillers of equal capacity and from the same manufacturer, a plurality of cooling towers, a plurality of chilled water pumps and a plurality of condenser water pumps arranged in parallel and coupled to a common header on a chilled water side and a common header on a condenser water side, the method comprising:
identifying each of the plurality of chillers in the chiller plant;
identifying each of the plurality of cooling towers in the chiller plant;
identifying each of the plurality of chilled water pumps in the chiller plant;
identifying each of the plurality of condenser water pumps in the chiller plant;
generating a chiller performance model and a chiller stalling model for each of the plurality of chillers in the chiller plant;
generating a cooling tower performance model for each of the plurality of cooling towers in the chiller plant;
generating a chilled water pump performance model for each of the plurality of chilled water pumps in the chiller plant;
generating a condenser water pump model for each of the plurality of condenser water pumps in the chiller plant;
formulating a chiller plant optimization model;
receiving chiller plant input data from the chiller plant;
solving the chiller plant optimization model using the chiller plant input data;
generating optimized chiller plant subsystems outputs;
comparing the optimized chiller plant subsystems outputs to current operating chiller plant subsystems;
generating projected energy savings of the optimized chiller plant subsystems;
comparing the projected energy savings to an energy saving threshold value;
when the projected energy savings exceeds the energy saving threshold value, sending the optimized chiller plant subsystems output to a building control system.

2. The method of claim 1, wherein the chiller plant input data includes building load, ambient air conditions and number of currently operating chillers.

3. The method of claim 2, wherein the ambient air conditions includes dry bulb temperature and relative humidity.

4. The method of claim 1, wherein the optimized chiller plant subsystems output includes number of the plurality of chillers to operate and fan speed of the plurality of cooling towers.

5. The method of claim 1, wherein the energy savings threshold value is set to be not less than 2 percent.

6. The method of claim 1, wherein generating a chiller performance model for each of the plurality of chillers in the chiller plant includes generating a characteristic curve for each of the plurality of chillers.

7. The method of claim 6, wherein generating a characteristic curve for each of the plurality of chillers includes generating a characteristic curve based on data provided by the manufacturer of the chiller.

8. The method of claim 6, wherein generating a characteristic curve for each of the plurality of chillers includes generating a characteristic curve based on data recorded from the chiller plant.
